(19) United States
(12) Patent Application Publication
(10) Pub. No.: US 2026/0129144 A1
(43) Pub. Date: May 7, 2026

(54) Image processing method, video processor and display system for performing MEMC

(71) Applicant: NOVATEK Microelectronics Corp., Hsin-Chu (TW)

(72) Inventors: Yun-Yang Chang, New Taipei City (TW); Yen-Sung Chen, New Taipei City (TW); Chih-Chia Kuo, Hsinchu City (TW)

(73) Assignee: NOVATEK Microelectronics Corp., Hsin-Chu (TW)

(21) Appl. No.: 18/935,685

(22) Filed: Nov. 4, 2024

(51) Int. Cl. H04N 7/01; G06T 7/20; H04N 5/14

(52) U.S. Cl. CPC H04N 7/014; G06T 7/20; H04N 5/145

(57) ABSTRACT

An image processing method for a video processor to generate an interpolated frame includes steps of: receiving a touch information from a host processor or a display driver circuit; finding at least one motion vector (MV) by performing motion estimation according to the touch information; and constructing the interpolated frame by using the at least one MV.

### BACKGROUND OF THE INVENTION

### 1. Field of the Invention

The present invention relates to an image processing method, and more particularly, to an image processing method performed in motion estimation and motion compensation (MEMC).

### 2. Description of the Prior Art

Motion estimation and motion compensation (MEMC) is a technology used for frame interpolation, which allows a series of image frames to be displayed with a higher frame rate. For example, if a 30 Hz source video such as a film is required to be displayed in 60 Hz, an interpolated frame should be added between every two adjacent input frames of the source video, so as to double the frame rate. The images of the interpolated frame may be predicted by using motion vectors (MVs) between a current input frame and a previous input frame, so as to display the output video smoothly.

In the MEMC operations, new images of the interpolated frame are generated by using predicted MVs, which might not be true MVs. If the calculated MVs have an error, several side effects, such as fade-in, fade-out, halo, and broken, may appear on the interpolated images. It is difficult to deal with these side effects with currently available MEMC algorithms.

### SUMMARY OF THE INVENTION

It is therefore an objective of the present invention to provide an image processing method performed in motion estimation and motion compensation (MEMC), in order to solve the abovementioned problems.

An embodiment of the present invention discloses an image processing method for a video processor, to generate an interpolated frame. The image processing method comprises steps of: receiving a touch information; finding at least one motion vector (MV) according to the touch information; and constructing the interpolated frame by using the at least one MV.

Another embodiment of the present invention discloses a video processor used to generate an interpolated frame. The video processor comprises a motion estimation (ME) circuit and a motion compensation (MC) circuit. The ME circuit receives a touch information and finds at least one MV according to the touch information. The MC circuit constructs the interpolated frame by using the at least one MV.

Another embodiment of the present invention discloses a display system, which comprises a host processor, a video processor and a display driver circuit. The host processor generates a previous frame and a current frame. The video processor, which is coupled to the host processor, generates an interpolated frame according to the previous frame and the current frame. The video processor comprises an ME circuit and an MC circuit. The ME circuit receives a touch information and finds at least one MV according to the touch information. The MC circuit constructs the interpolated frame by using the at least one MV. The display driver circuit, coupled to the video processor, drives a display panel to display the interpolated frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display system according to an embodiment of the present invention.

FIG. 2 is a schematic diagram of another display system according to an embodiment of the present invention.

FIG. 3 illustrates that a touch object moves to generate a displacement.

FIG. 4A and FIG. 4B illustrate that the ME circuit searches the blocks according to the moving direction of the touch gesture.

FIG. 5 is a flowchart of an image processing process according to an embodiment of the present invention.

### DETAILED DESCRIPTION

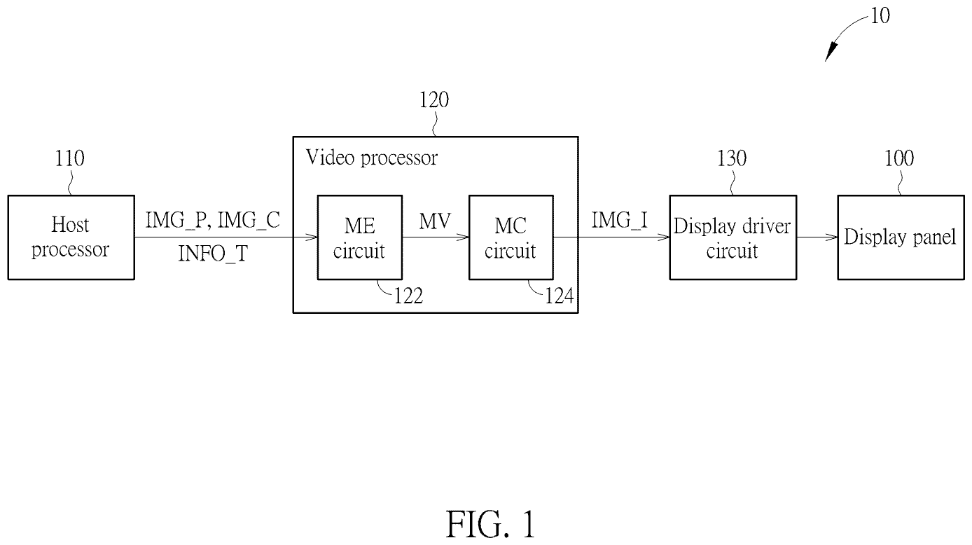

FIG. 1 is a schematic diagram of a display system 10 according to an embodiment of the present invention. The display system 10 includes a display panel 100, a host processor 110, a video processor 120 and a display driver circuit 130. The display system 10 may be implemented in any electronic device having a display panel or screen and capable of display functions. The display panel 100 may be any type of display device, which includes, but not limited to, a light emitting diode (LED) panel, organic LED (OLED) panel, and liquid crystal display (LCD) panel.

The host processor 110, which may be a core processor of the display system 10, may serve as a video source or video provider for providing image data to be displayed by the display panel 100. In an embodiment, the host processor 110 may be an application processor (AP) of a mobile phone or a central processing unit (CPU) of a computer. In fact, the host processor 110 may represent any type of processor or processing device capable of controlling the overall system and implemented in any manner.

The display driver circuit 130 may process the image data and convert the image data into data voltages to be output to the pixels on the display panel 100. In various embodiments of the present invention, the display panel 100 may be a touch panel, and thus the display driver circuit 130 may also be capable of controlling the touch operations of the display panel 100. In an embodiment, the display driver circuit 130 may be implemented in an integrated circuit (IC), and with the display driving and touch sensing operations, the display driver circuit 130 may be a touch and display driver integration (TDDI) IC. In fact, the display driver circuit 130 may represent a circuitry capable of controlling the display driving and touch sensing operations of a display device and implemented in any manner.

The video processor 120, which may be coupled between the host processor 110 and the display driver circuit 130, may receive the image data from the host processor 110 and generate an output image data based on the display requirements. In general, the display panel 100 usually displays with a higher frame rate which is greater than the original frame rate of the image data provided by the host processor 110. The video processor 120 may serve as a frame rate converter to generate a series of image frames with the desired frame rate, which may be realized by using the motion estimation and motion compensation (MEMC) technology. The video processor 120 may be implemented in any manner. In an exemplary embodiment, the video processor 120 may be implemented in a discrete graphics card. Alternatively, the video processor 120 may be integrated with the host processor 110 and/or the display driver circuit 130.

Based on a previous frame IMG_P and a current frame IMG_C of image data received from the host processor 110, the video processor 120 may perform MEMC to generate an interpolated frame IMG_I, and then output the interpolated frame IMG_I to the display driver circuit 130. For example, the interpolated frame IMG_I may have multiple blocks, where the images in each block may be predicted by choosing a best motion vector (MV), which is directed to the images that might be most identical to the desired images in the block. Therefore, the images of the block may be taken from the area directed by the best MV. In various embodiments of the present invention, in order to improve the accuracy of MV prediction, the video processor 120 may obtain the best MV according to the touch information, which indicates the touch operation performed before the images of the interpolated frame IMG_I are to be generated and displayed.

In detail, the video processor 120 includes a motion estimation (ME) circuit 122 and a motion compensation (MC) circuit 124. The ME circuit 122 may estimate the motion of objects in the images, to determine the best MV for each block. In various embodiments, the ME circuit 122 may receive a touch information INFO_T from the host processor 110 and perform ME accordingly. More specifically, the ME circuit 122 may find one or more MVs (e.g., the best MV) for each block of the interpolated frame IMG_I according to the touch information INFO_T. The ME circuit 122 then provides the MV(s) for the MC circuit 124 to perform subsequent operations.

By using the MV(s) received from the ME circuit 122, the MC circuit 124 may construct the interpolated frame IMG_I. For example, as for each block, the MC circuit 124 may obtain the images from the area directed by the best MV, so as to construct the images of the interpolated frame IMG_I. By receiving the image data in the interpolated frame IMG_I and other related image frames (e.g., including IMG_P and IMG_C), the display driver circuit 130 may drive the display panel 100 to display these images.

Therefore, the ME circuit 122 may perform ME based on the touch information INFO_T, so as to improve the performance of ME and reduce the defects in the interpolated images. Note that the touch behavior is usually influenced by the image content, predefined settings may be applied under several specific scenarios. The touch information INFO_T that may be involved in the MEMC may include, but not limited to, the moving direction of the touch gesture, the displacement of the touch gesture, and a touch event such as a click at a specific position.

In an embodiment, the video processor 120 may receive the touch information INFO_T from the host processor 110 through the mobile industry processor interface (MIPI) which is also used for delivering the image data. For example, based on the image data format, the touch information INFO_T may be carried in a blanking interval, such as the vertical blanking interval between image frames.

As mentioned above, the display driver circuit 130 may control the touch operations of the display panel 100, and thus it will obtain the related touch information INFO_T. The display driver circuit 130 may provide the touch information INFO_T or related data to the host processor 110. Therefore, the host processor 110 is able to send the touch information INFO_T with the image data to the video processor 120.

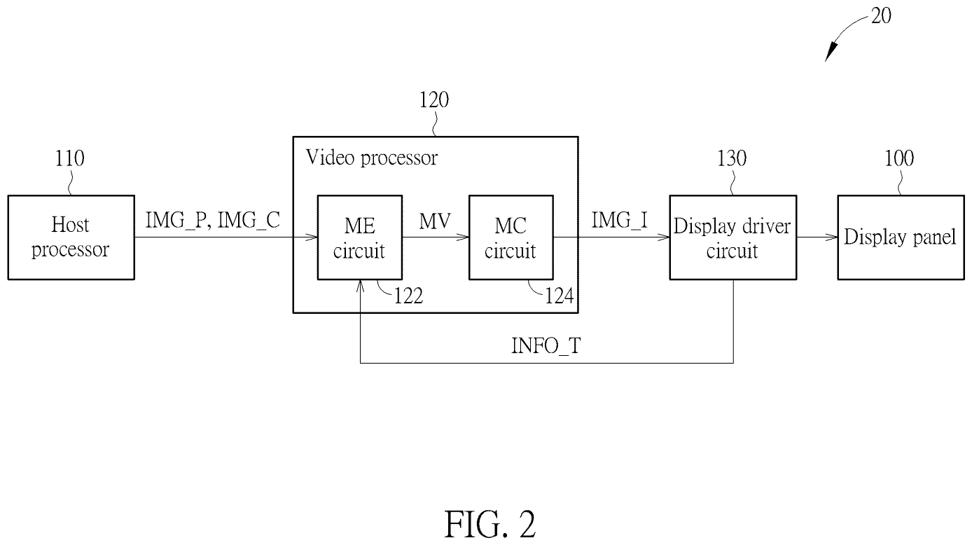

Note that the above method of providing the touch information INFO_T to the video processor 120 is one of various implementations of the present invention. In another embodiment, the host processor 110 may send the touch information INFO_T to the video processor 120 through another interface. In a further embodiment, the video processor 120 may directly receive the touch information INFO_T from the display driver circuit 130, as shown in FIG. 2.

FIG. 2 is a schematic diagram of another display system 20 according to an embodiment of the present invention. The structure of the display system 20 is similar to the structure of the display system 10, so signals and elements having similar functions are denoted by the same symbols. The difference between the display system 20 and the display system 10 is that, in the display system 20, the video processor 120 receives the touch information INFO_T from the display driver circuit 130. Based on the touch information INFO_T received from the display driver circuit 130, the video processor 120 may perform MEMC operations in a similar manner.

In an exemplary embodiment, the display driver circuit 130 may send the touch information INFO_T to the video processor 120 through a serial peripheral interface (SPI) or another type of interface, where the transmission medium will not be a limitation of the scope of the present invention.

The video processor 120 may apply the touch information INFO_T in the MEMC operations in various manners. In an embodiment, the touch information INFO_T includes the displacement of a touch gesture, such as the moving distance of a user's finger swiping on the touch panel. Therefore, the ME circuit 122 may perform ME to obtain the MV(s) according to the displacement of the touch gesture.

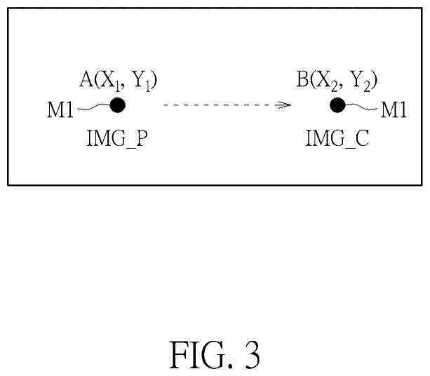

More specifically, the ME circuit 122 may obtain the position of a touch object (e.g., the finger) at a series of time points, where each time point may correspond to an image frame. The displacement may be obtained by calculating the difference of the positions of the touch object between two adjacent time points. For example, as shown in FIG. 3, a touch object M1 may be at the position A with the coordinate (X₁, Y₁) at an earlier time point corresponding to the previous frame IMG_P, and then move to the position B with the coordinate (X₂, Y₂) at a later time point corresponding to the current frame IMG_C. The ME circuit 122 may thereby calculate the displacement of the touch object M1 as (X₂-X₁, Y₂-Y₁).

The swipe gesture may usually be used to drag an object in the image. However, the swipe distance/displacement on the touch panel is usually different from the moving distance/displacement of this object in the image, and thus a conversion is necessary. Under most scenarios, the displacement of the swipe gesture is linearly proportional to the displacement of the dragged object. Supposing that all objects in the image move with an equal speed, the ME circuit 122 may take a global MV to determine the displacement of the image, where the global MV may be an MV that appears the most times during the ME operations. The ME circuit 122 may thereby calculate a ratio of the displacement of the swipe gesture and the displacement of the image (i.e., the global MV). Subsequently, this ratio may be used to convert the displacement of the swipe gesture into the moving distance of the target object in the image. In such a situation, the best MV (i.e., the final MV) of this object may be found according to the calculated moving distance. The MC circuit 124 then takes the best MV to perform subsequent MC operations for the block(s) associated with this object.

In another embodiment, the movement of the touch object may also be used as a reference to perform ME operations. For example, the information of the moving direction of the touch gesture may be included in the received touch information INFO_T. The ME circuit 122 may search the MVs by referring to the moving direction of the touch gesture.

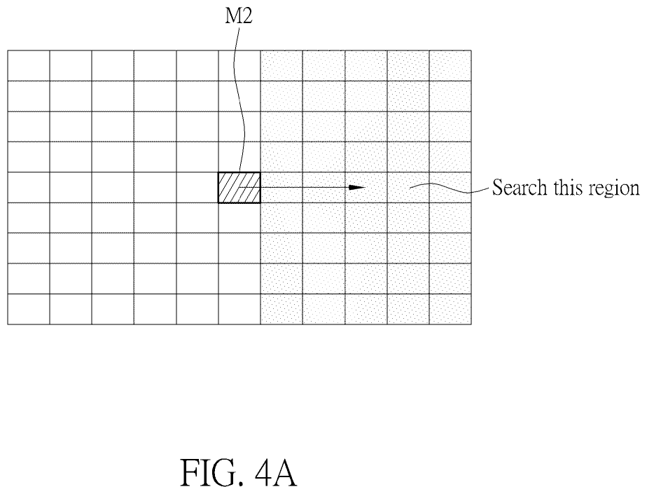

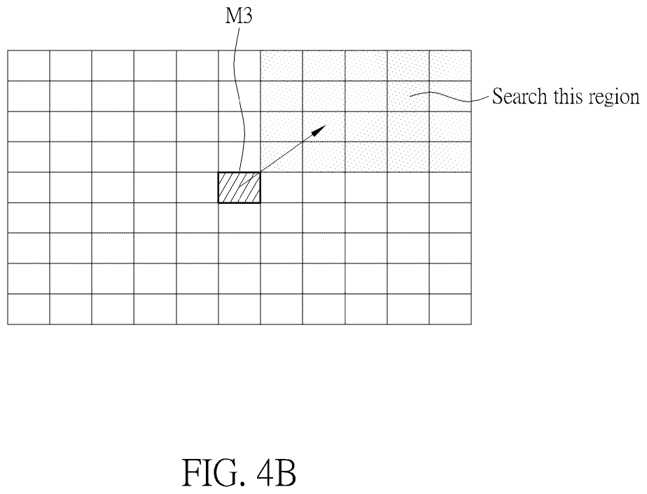

FIG. 4A illustrates that the ME circuit 122 searches the blocks according to the moving direction of the touch gesture. Each grid shown in FIG. 4A may represent a block (e.g., macroblock) of the present frame IMG_P or the current frame IMG_C. If there is no information of the moving direction of the touch gesture, the ME circuit 122 may search all blocks to find the best MV; that is, to find the image most similar to the desired image in the corresponding block of the interpolated frame IMG_I. When taking the moving direction of the touch gesture into consideration, the ME circuit 122 may perform searching only in the region corresponding to the moving direction of the touch gesture, which may be a region to which a target object is predicted to move in the interpolated frame IMG_I. More specifically, the ME circuit 122 may search and obtain the candidate MVs only in the region corresponding to the moving direction of the touch gesture, and select the best MV (i.e., the final MV) from these candidate MVs.

As shown in FIG. 4A, the received touch information INFO_T indicates that a touch gesture moves rightwards. Therefore, the ME circuit 122 may only search the region at the right of the object M2 controlled (e.g., dragged) by the touch gesture (i.e., search the dotted blocks), to find the target image to be taken for the object M2 (and/or its block) from the right side. The search is only performed on the blocks at the right side of the object M2; hence, the amount of computation performed in ME may be significantly reduced, which leads to a tremendous improvement of ME performance.

In another embodiment, in order to further reduce the amount of computation, the searching region may further be limited to the blocks that the object controlled by the touch gesture are more probably dragged to. For example, as shown in FIG. 4B, the ME circuit 122 may obtain the movements of the object M3 in both the X-axis direction and the Y-axis direction. In this embodiment, the object M3 is expected to move to the upper right side based on the moving direction of the touch gesture. Therefore, the ME circuit 122 will only search the blocks in the region of the upper right side of the object M3 (i.e., search the dotted blocks) to find the best MV, thereby achieving further less computation amount and higher ME performance. In an exemplary embodiment, the ME circuit 122 may apply an algorithm to only take the candidate MVs having an X-value greater than 0 (i.e., corresponding to the right-side blocks) and a Y-value greater than 0 (i.e., corresponding to the upper-side blocks) to determine the similarity and find the best MV.

Common touch gestures generally include swipe and click. The above embodiments perform ME by taking the swipe direction and displacement into account. In the following embodiment, another touch event (e.g., the click gesture) may be applied as a reference to perform ME. Based on the touch event, the ME circuit 122 may timely apply a protection scheme to avoid unwanted defects in the interpolated images.

Note that the image content shown on the display panel 100 is provided from the video processor 120. In an embodiment, the video processor 120 may generate the image data based on the control of touch events; that is, a user may apply an appropriate touch gesture to control the display panel 100 to show a desired image at a subsequent time point. When some specific touch events occur, the image may be predicted to have high complexity such that the MEMC algorithm may not appropriately deal with this scenario and unwanted side effects may appear. In order to avoid such defects, when any of the predetermined touch events appears, the ME circuit 122 may determine that a specific scenario may appear, and thus forcibly take a zero MV as the best MV. In other words, under the scenario that the image may become complex according to the touch gesture, the ME circuit 122 may stop the ME operations, but instead it will take the original image in the same block of the previous frame IMG_P to generate the desired image in the interpolated frame IMG_I, which means that the ME circuit 122 takes the zero MV as the final MV. Since the interpolated image is exactly obtained from the same block in the previous frame IMG_P, the image in the specific block(s) of the interpolated frame IMG_I may be perfectly copied from the previous frame IMG_P; hence, no unwanted side effects or defects will be generated.

For example, in a game application, the user may click a button to open a complex page which may not be easily processed through MEMC to generate satisfactory interpolated images. When the received touch information INFO_T indicates that there is a click on the position of the button, the ME circuit 122 may determine that the complex page will be open, and thus apply a protection scheme for the corresponding area. In an embodiment, the ME circuit 122 may have a complexity meter which indicates the complexity of each image or each frame, and determine whether to apply the protection scheme according to the complexity meter. In an exemplary embodiment, the zero MV may be taken as the final MV to generate the interpolated images in the protected area.

Note that the present invention aims at providing a novel image processing method where the MEMC is performed according to the touch information. Those skilled in the art may make modifications and alterations accordingly. For example, the above embodiments respectively use the information of the displacement of the touch gesture, the moving direction of the touch gesture and the click operation to perform ME and find the MV. In another embodiment, several or all of these implementations may be combined to further improve the performance of MEMC. In addition, the touch information received by the ME circuit may not be limited to those described in this disclosure. For example, another touch event may be used to perform the above protection scheme; that is, the zero MV may be forcibly used when another touch event occurs. For example, when the motion of an object is greater than a threshold (e.g., the displacement is in an excessively large level), the ME circuit may determine that it is not easy to handle the MEMC satisfactorily. In such a situation, the protection scheme may be triggered and the zero MV may be used.

In an embodiment, before the ME circuit 122 receives the touch information INFO_T from the host processor 110, the host processor 110 may perform pre-processing on the touch information INFO_T. For example, the host processor 110 may filter out several touch data that might not be correct. In an embodiment, the host processor 110 may detect one or more specific touch events for triggering the protection scheme of MEMC, and send the detection result to the ME circuit 122, allowing the ME circuit 122 to determine whether to apply the zero MV according to the detection result of the host processor 110.

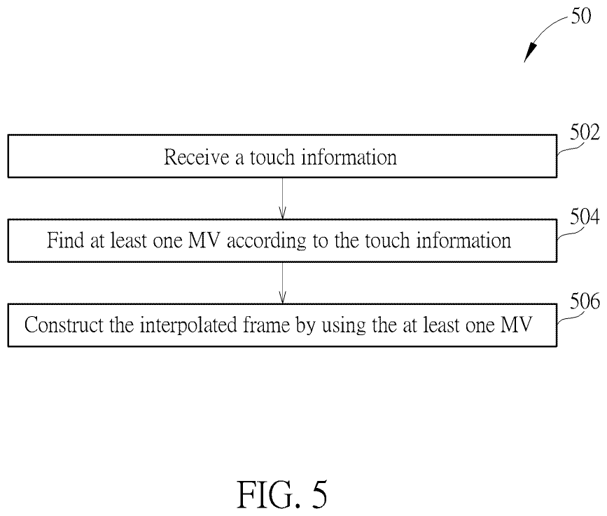

The abovementioned operations of handling MEMC according to the touch information may be summarized into an image processing process 50, as shown in FIG. 5. The image processing process 50 may be implemented in a video processor of a display system, such as the video processor 120 shown in FIG. 1 or 2. As shown in FIG. 5, the image processing process 50 includes the following steps:
Step 502: Receive a touch information.
Step 504: Find at least one MV according to the touch information.
Step 506: Construct the interpolated frame by using the at least one MV.

The detailed operations and alterations of the image processing process 50 are illustrated in the above paragraphs, and will not be narrated herein.

To sum up, the present invention provides a novel image processing method and a related video processor, where MEMC may be performed according to the touch information. The video processor may receive the touch information from a host processor (e.g., AP) or a display driver circuit (e.g., TDDI IC). The touch information used for MEMC may include, but not limited to, the displacement and/or moving direction of the touch gesture, and any touch event such as a click operation. In various embodiments, the touch information may be used as a reference to generate the MV for each block, so as to improve the performance of MEMC.

Those skilled in the art will readily observe that numerous modifications and alterations of the device and method may be made while retaining the teachings of the invention. Accordingly, the above disclosure should be construed as limited only by the metes and bounds of the appended claims.

1. An image processing method for a video processor to generate an interpolated frame, the image processing method comprising:
receiving a touch information;
finding at least one motion vector (MV) according to the touch information; and
constructing the interpolated frame by using the at least one MV;
wherein the touch information comprises a moving direction of a touch gesture, and the step of finding the at least one MV according to the touch information comprises:
searching a plurality of candidate MVs only in a region corresponding to the moving direction of the touch gesture; and
selecting a second MV among the at least one MV from the plurality of candidate MVs.

2. The image processing method of claim 1, wherein the touch information is received from a host processor.

3. The image processing method of claim 1, wherein the touch information is received from a display driver circuit.

4. The image processing method of claim 1, wherein the touch information further comprises at least one of a displacement of the touch gesture and a touch event.

5. The image processing method of claim 4, wherein the step of finding the at least one MV according to the touch information comprises:
converting the displacement of the touch gesture into a moving distance of an object in an original image; and
finding a first MV among the at least one MV according to the moving distance of the object.

6. (canceled)

7. The image processing method of claim 4, wherein the step of finding the at least one MV according to the touch information comprises:
determining a scenario corresponding to the touch event; and
forcibly taking a zero MV as a third MV among the at least one MV under the scenario.

8. A video processor to generate an interpolated frame, the video processor comprising:
a motion estimation (ME) circuit to receive a touch information and find at least one motion vector (MV) according to the touch information; and
a motion compensation (MC) circuit to construct the interpolated frame by using the at least one MV;
wherein the touch information comprises a moving direction of a touch gesture, and the ME circuit searches a plurality of candidate MVs only in a region corresponding to the moving direction of the touch gesture, and selects a second MV among the at least one MV from the plurality of candidate MVs.

9. The video processor of claim 8, wherein the ME circuit receives the touch information from a host processor.

10. The video processor of claim 8, wherein the ME circuit receives the touch information from a display driver circuit.

11. The video processor of claim 8, wherein the touch information further comprises at least one of a displacement of the touch gesture and a touch event.

12. The video processor of claim 11, wherein the ME circuit converts the displacement of the touch gesture into a moving distance of an object in an original image, and finds a first MV among the at least one MV according to the moving distance of the object.

13. (canceled)

14. The video processor of claim 11, wherein the ME circuit determines a scenario corresponding to the touch event, and forcibly takes a zero MV as a third MV among the at least one MV under the scenario.

15. A display system comprising:
a host processor to generate a previous frame and a current frame;
a video processor, coupled to the host processor, to generate an interpolated frame according to the previous frame and the current frame, the video processor comprising:
a motion estimation (ME) circuit to receive a touch information and find at least one motion vector (MV) according to the touch information; and
a motion compensation (MC) circuit to construct the interpolated frame by using the at least one MV; and
a display driver circuit, coupled to the video processor, to drive a display panel to display the interpolated frame;
wherein the touch information comprises a moving direction of a touch gesture, and the ME circuit searches a plurality of candidate MVs only in a region corresponding to the moving direction of the touch gesture, and selects a second MV among the at least one MV from the plurality of candidate MVs.

16. The display system of claim 15, wherein the ME circuit receives the touch information from the host processor.

17. The display system of claim 15, wherein the ME circuit receives the touch information from the display driver circuit.

18. The display system of claim 15, wherein the touch information further comprises at least one of a displacement of the touch gesture and a touch event.

19. The display system of claim 18, wherein the ME circuit converts the displacement of the touch gesture into a moving distance of an object in an original image, and finds a first MV among the at least one MV according to the moving distance of the object.

20. (canceled)

21. The display system of claim 18, wherein the ME circuit determines a scenario corresponding to the touch event, and forcibly takes a zero MV as a third MV among the at least one MV under the scenario.
